(19) United States
(12) Patent Application Publication
(10) Pub. No.: US 2007/0035694 A1
(43) Pub. Date: Feb. 15, 2007

(54) Light filtering nonprescription temporary reading glasses

(76) Inventor: Carolyn S. Keller, Reno, NV (US)

Correspondence Address: Carolyn Keller, P O Box 2841, Reno, NV, 89503, US

(21) Appl. No.: 11/204,451

(22) Filed: Aug. 15, 2005

(51) Int. Cl. G02C 7/10

(52) U.S. Cl. 351/163

(57) ABSTRACT

One possible embodiment of the invention could be nonprescription temporary reading glasses comprised of frame holding a set of lenses, the frame being adapted to hold the lenses in proper orientation in relation to the wear's eyes. The lenses having equal powers of magnification, the magnification not being set to an specific optical prescription for a particular wearer, the lenses further containing tints, polarizers, chromatic tints which can be used to help reduce the brilliance of the light passing through the lenses so that the amount of light passing through the lenses may be comfortably viewed by the wearer.

### CROSS-REFERENCES TO RELATED APPLICATIONS

Not Applicable.

### STATEMENT REGARDING FEDERALLY SPONSORED RESEARCH OR DEVELOPMENT

Not Applicable

### REFERENCE TO A “MICROFICHE APPENDIX”

Not Applicable.

### FIELD OF THE INVENTION

The present invention relates to magnification eyewear and more particularly to non-prescription, temporary eyeglasses used for reading.

### BACKGROUND

As the current baby boomer generation continues to age, there has been a significant increase in the usage of instrumentalities to aid the vision. Normally, to selectively view and focus on objects that are at different distances from the eye(s), the focal length of the eye's lens must change. This means eye's lens must be adjusted so that the light reflected by the object and passing into the eye generally has to be properly focused at the back of the eye or retina. In a healthy eye, this lens adjustment is achieved through the contraction of muscles that are attached to the lens. When the muscle contracts, it deforms the lens changing the focal length of the lens. In doing so, it becomes possible to focus the eye on objects that are at different distances from the eye.

As person ages, the lens become less flexible and the lens muscles become weaker causing a loss of ability to focus (e.g., engage in accommodation). Another possibility is Myopia (nearsightedness) or Hyperopia (farsightedness) which may occur during aging when the size of skull's eye orbital changes in relation to the size and shape of eye thus moving the focal point of the eye lens way from the retina. These and other related factors (e.g. ocular diseases), may cause different levels of impairment and disability as the individual ages.

One such solution for Myopia and Hyperopia is Lasik (Laser-Assisted In Situ Keratomileusis) eye surgery wherein a laser is used to cut and shape the cornea (the transparent part of the coat of the eyeball that covers the iris and pupil and admits light to the interior of the eye). This procedure permanently changes the shape of the cornea, the clear covering of the front of the eye, using a laser vaporize a portion of the middle section of the cornea. Such surgery does pose risks such as loss of vision, development of debilitating visual symptoms, over or under correcting of the vision, development of severe dry eye syndrome; and long-term safety and effectiveness of LASIK surgery is not known. Further, this surgery may not necessarily address the issues of impairment of accommodation (focusing on object at various distances from the eye.

As a less permanent form of treatment is the use of prescription eyewear. In making prescription eyewear or glasses, ophthalmologists and optometrists measure the vision of the patient, determine the measurements of appropriate corrective lens, then have the lenses of selected eyewear made to corrective specifications via an optical prescription. What may occur is that multiple corrections may be required for the patient to allow the patient to see at various distances that patient's vision is applied to. For example, due to inability to focus at certain distances, the patient may need one prescription for driving, another prescription for reading, and yet another prescription for looking at objects close up. One approach could be multiple sets of prescription glasses for various viewing activities and change the glasses as needed. This may be considered inconvenient both because of the need to carry multiple pairs of glasses and because of the need to swap glasses frequently.

Another approach is to have the eyewear lenses incorporate multiple optical corrections giving such prescription lens multiple focal points (e.g., bifocal, trifocal glasses). To create such lens, a lower part of the lens is ground to provide a correction suitable for reading or other close-up work while the remainder of the lens is ground to provide a correction for distance vision. To view an object, the wearer of a multifocal lenses eyewear tilts the wearer's head to look though that portion of the lens which is ground to view the object at the distance range for that portion of the lens. The reflection of the object then passes through the appropriately optically corrected portion of the lens. One possible limitation to this solution could be the expense of producing multifocal lenses. Additionally, it may take a patient awhile to learn how to switch their eyes from one corrected section of the lens to another corrected section. Further, a patient may experience some nausea when looking and focusing through multifocal eyewear.

With older patients, their eyes may change between visits to the eye doctor, but not sufficient to warrant (in the opinion of the patient) obtaining expensive new pair of glasses. The patient then may obtain a pair of temporary or non-prescription reading glasses for up close reading of documents (e.g., newspapers, books, electronic formats, and the like). These types of reading glasses are not made to a specific prescription to correct the impaired vision of a particular patient, rather they come in various grades of visual magnification and are selected, generally without help or assistance by ophthalmologists and optometrists, by the patient on the basis of trial and error at the store which sells such glasses. These temporary reading glasses generally are not for long term vision enhancement but temporary reading or other observation, such as reading a menu at a restaurant.

One possible feature that the baby boomer generation may have to distinguish it from its more immediate predecessors is that the baby boomer generation generally utilizes a greater portion of its time in engaging in outdoor leisure activities as it ages than did its more immediate proceeding generations. As such, the contemporary nonprescription reading glasses, which may have been generally established by earlier generations, may not generally take into account outdoor usage of such glasses. The baby boomers, while outdoors, like to read outdoors as well. This leads to issues when using temporary or non-prescription reading glasses, which the older generations traditionally used to read indoors. Traditionally, the non-prescription temporary reading glasses have a clear or fully translucent lens, which substantially allow full passage of light through them while the equal magnification of both lens may help concentrate the incoming light and its brightness through the eyewear. In certain circumstances, such as reading the books outdoors, the white background of the paper pages may reflect a significant amount of sunlight through the reading glasses. The intensity of the reflected and magnified outdoor sunlight may be overpowering to a user of non-prescription reading glasses while reading outdoors causing viewing discomfort.

What is needed therefore are non-prescription reading glasses that can reduce or limit brightness intensity or brilliance of the light (e.g., sunlight) through the non-prescription temporary reading glasses without reducing the reading or magnification capacity of the eyewear.

### SUMMARY OF ONE EMBODIMENT OF THE INVENTION

Advantages of One or More Embodiments of the Present Invention

The various embodiments of the present invention may, but do not necessarily, achieve one or more of the following advantages:

the ability to allow non-prescription magnification eyewear to used to be for reading outdoors,

provide a non-prescription magnification eyewear which may limit at least a portion of the intensity of the reflected sunlight passing through the eyewear, and

provide a non-prescription magnification eyewear which may limit passage through the lens of ultraviolet light.

These and other advantages may be realized by reference to the remaining portions of the specification, claims, and abstract.

### BRIEF DESCRIPTION OF ONE EMBODIMENT OF THE PRESENT INVENTION

One possible embodiment of the invention could be a temporary nonprescription reading glasses comprising a frame holding a set of lenses, the set of lenses providing a capability of magnifying light entering the lenses, the magnification not being based on a particular optical prescription for adjusting the vision of particular wearer, wherein the lenses further containing a tint of sufficiently strong concentration to reduce the brilliance of light passing through the lenses so amount of light passing through the lenses may be comfortably viewed by the wearer.

Another version of the invention could be a non-prescription temporary reading eyewear comprising a frame, the frame being adapted to hold a set of lenses in proper orientation in relation to the wear's eyes, each of the lenses having a level of magnification, which is not predetermined by an specific optical prescription for a particular wearer; each magnifying lens containing polarizers.

Another version of the invention could be Non-prescription temporary reading eyewear whose lens provide equal magnification of at least one object being viewed by the wearer comprising: a frame holding a set of magnifying lenses, the lenses having level of magnification that is not set by an optical prescription for a particular wearer, the lenses are constructed to contain a light reducing means.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a perspective view of one embodiment of the present invention.

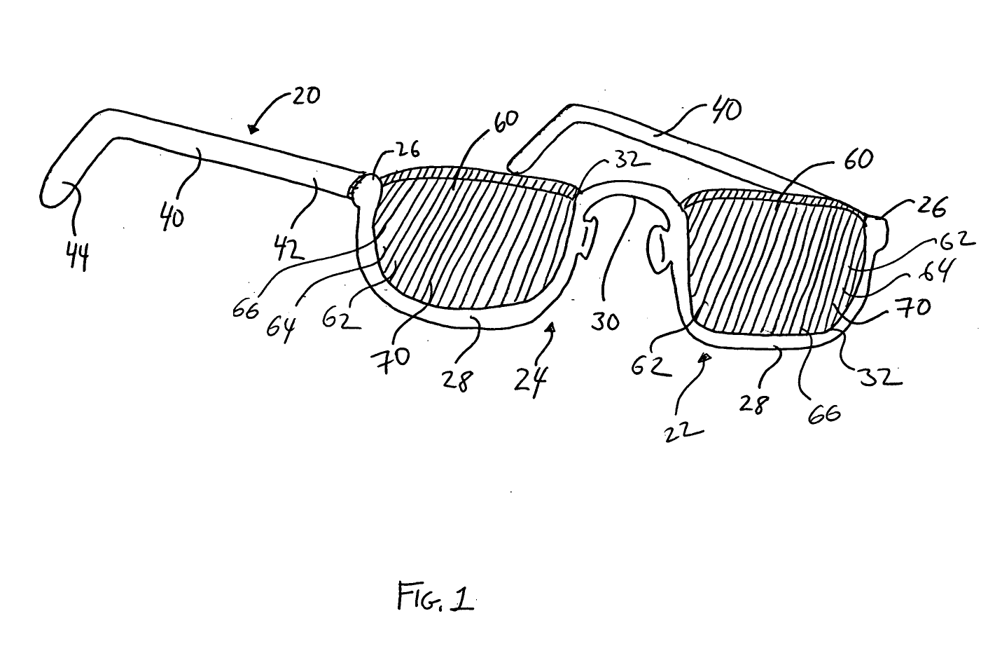

### DESCRIPTION OF CERTAIN EMBODIMENTS OF THE PRESENT INVENTION

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

The present invention comprises a non-prescription magnification eyewear 10 which may comprise of a frame 20 and a set of lens 60. The frame 20 may be comprise of lens holding section 22, and two arms 40 hingedly connected to the lens holding portion 28. The frame 20 may be constructed of suitable polymer and be manufactured using inexpensive mold injection techniques.

The lens holding section 22 may be adapted to hold in fixed relationship the set of lens 40. The distance by which the lens 40 being held apart by the lens holding section 22 may conform to average distances that are found between the eyes of most intended users. The lens holding section 22 may comprise a body 24 generally defined by two ends 26, two lens holding portions 28, which substantially separated by a midsection 30 for partially mounting the eyewear substantially proximate to the bridge of the nose of the intended wearer. The midsection 30 may have recess of sufficient size and shape for comfortably accommodating at least a portion of the average sized nose of the prospective wearers. Each lens holding portion 28 may an aperture 30, which may have a grooved edge into which at least a portion of an edge of a respective lens 60 may be located and be held by a force or friction fit onto at least a portion of the lens holding portion 28.

Each arm 40 may have respective proximal end 42 and distal end 44, the proximate end being hingedly attached each to a respective end 26 of the body 24. The distal end 44 being shaped and sized to generically engage the back of the wearer's ear and head. In nonuse, the arms 40 can be folded by their hinges across one another and across the back the lens holding section 22.

The set of lenses 60 may be made of a suitable glass or polymer material and shaped so as to have similar optical magnification or power. In this manner, the lens 60 may be seen as having two sides where in both sides have curvature or one side has curvature and the other side is planar so that light entering (and/or emerging from the lens 40) is bent (refracted) by one or more of the curvatures. In bending or refracting the light passing through the lens 40, the focal point of the lens 40 and hence the invention may be obtained. This shaping of the lens 40 may used to produce a general power of magnification for the eyewear rather than shaping the lens pursuant to a specific optical prescription made to corrective specifications determined by an ophthalmologist, optometrist, and the like to meet the specific visual needs (provide corrective vision) of a particular user.

The lenses 60 should further incorporate a light reducing means 70 or an ability to lessen the transmission of light (e.g., sunlight) through the lens 60. In this manner, the brilliance of light (e.g. sunlight or other light passing into the lens 60) could be generally reduced so that the light passing out of the lens 60 may be comfortably viewed by the wearer. If the brilliance of light being observed by the viewer (e.g. wearer) is too powerful for the eye to compensate by constricting the pupil, the viewer may experience physical discomfort from continued viewing of such strong light (as well as possible damage to the eye).

One such light reducing means 70 could be the tinting of the lens 60 through the placement of tints via dyes placed into the lenses 60 during lenses construction. Tints 62 can be applied to glass as well as plastic lenses. Lighter tints 62 may be used for fashion and cosmetic appearance of the invention while darker tint is may be used to reduce some of the brilliance of sunlight as it passes through the lenses 60. A tint 62 can be solid, when the entire lens is the same color, or gradient, which is a gradual fade from dark to light, usually fading from the top down. The above tinting is a constant tint 62 in that it does not change in intensity (e.g., transparency) due to environmental factors.

Another type of tint which may be employed by the invention is a photochromic tint 64 which may change its intensity (e.g., ability to block the transmission of light through the lens) in lo relation to the amount of ultraviolet light that is passing through the lens 60. In many such instances, photochromic dye is generally a silver halide distributed evenly through the body of the lens 60 during the manufacture of the lens 60. The whole lens 60 will change when exposed to light with the thicken portion of the lens being the darkest portion of the lens. Additionally some of the new chromatic dyes may cause the lens to change color as well as alter the darkness of the chromatic tint 64.

Another light blocking means may be use of vertically oriented polarizers 66 in the lens 60 to block the transmission of at least a portion of horizontally polarized light reflected from surfaces such as water and the like so as to substantially reduce glare accompanying such horizontally polarized light. Polarized lenses 60 may also incorporate photochromic tint 64 to become polarized photochromic lenses 60, which change from dark outside to light inside, are right for the light-sensitive, somewhat vision challenged person who changes environments frequently (inside to outside and vice versa).

### Conclusion

As can denoted above, the use of light reducing means in nonprescription, temporary reading glasses can allow an older more active generation to participate in more outdoor activities while simultaneously engaging in the pastime of reading.

Although the description above contains many specifications, these should not be construed as limiting the scope of the invention but as merely providing illustrations of some of the presently preferred embodiments of this invention. Thus, the scope of the invention should be determined by the appended claims and their legal equivalents rather than by the examples given.

What is claimed is:

1. A temporary nonprescription reading glasses comprising:
(A) a frame, the frame being adapted to hold a set of lenses in proper orientation in relation to the wear's eyes;
(B) the set of lenses providing a capability of magnifying light entering the lenses, the magnification of the light being the same for both lenses, the magnification not being based on a particular optical prescription for adjusting the vision of particular wearer;
(C) wherein the lenses further contain a tint of sufficiently strong concentration to reduce the intensity of a light passing into the lenses so amount of the light passing through the lenses may be comfortably viewed by the wearer.

2. A temporary nonprescription reading glasses of claim 1, the lenses further containing polarizers.

3. A temporary nonprescription reading glasses of claim 2, wherein the polarizers are vertically-oriented polarizers.

4. A temporary nonprescription reading glasses of claim 1, wherein the tint is a photochromic tint.

5. Non-prescription temporary reading eyewear comprising:
(A) a frame, the frame being adapted to hold a set of lenses in proper orientation in relation to the wear's eyes,
(B) a set of each magnifying lens, each magnifying lens having same level of magnification, the level of magnification is not predetermined by an specific optical prescription for a particular wearer, each magnifying lens containing polarizers.

6. Non-prescription temporary reading eyewear of claim 6 wherein the lenses further comprise of a tint which is of sufficient concentration to reduce the amount of light passing though the lenses so that the wearer can comfortably view the said light.

7. Non-prescription temporary reading eyewear of claim 6 wherein the lenses further comprise of a photochromic tint.

8. Non-prescription temporary reading eyewear whose lens provide equal magnification of at least one object being viewed by the wearer comprising:
(A) a frame holding a set of a lenses, the lenses having level of magnification that is not set by an optical prescription for a particular wearer.
(B) the set of lenses are constructed to contain light reducing means.

9. Non-prescription temporary reading eyewear of claim 8 wherein the light reducing means comprises a tint of sufficiently strong concentration to reduce the brilliance of the light passing through the lenses so as to be comfortably viewed by the wearer.

10. Non-prescription temporary reading eyewear of claim 8 wherein the light reducing means is a photochromic tint.

11. Non-prescription temporary reading eyewear of claim 8 wherein the light reducing means is a polarizer.

12. Non-prescription temporary reading eyewear of claim 11 wherein the light reducing means is a vertically oriented polarizer
